(19) United States
(12) Patent Application Publication
(10) Pub. No.: US 2014/0113269 A1
(43) Pub. Date: Apr. 24, 2014

(54) EDUCATIONAL TOY

(71) Applicant: Orion Mehus, Lynbrook, NY (US)

(72) Inventor: Orion Mehus, Lynbrook, NY (US)

(21) Appl. No.: 13/657,929

(22) Filed: Oct. 23, 2012

(51) Int. Cl. G09B 25/00

(52) U.S. Cl. 434/365

(57) ABSTRACT

An educational toy has four panels. Each panel is joined to the next panel with a hinge. Each panel has an outwardly facing surface. Educational information is disposed on each said surface. In an open position, the panels define a hollow cube, and in a closed position, the panels define a flat structure. The educational information may include, without limitation, letters, numbers, pictures, phrases, and combinations thereof. When the toy is in the closed position, one toy may be nested into another toy.

### FIELD OF THE INVENTION

The instant invention is directed to an educational toy.

### BACKGROUND OF THE INVENTION

Educational toys, such as wooden blocks, are well known. The faces of these blocks may be decorated with a variety of educational data. This data may include letters, numbers, pictures of animals, and the like. As children play with the blocks, they become familiar with the educational data. This familiarity facilitates learning.

Over the years, there have been numerous variations of wooden blocks. Each variation facilitates learning. Some of these variations may be found in U.S. Pat. Nos. 550,563; 3,407,514; 4,158,921; 4,778,392; and 4,875,681.

U.S. Pat. Nos. 550,563 and 4,158,921 show, in their respective FIGS. 1, a block having six (6) panels. These blocks do not have an open top and bottom. These blocks do not collapse between an open and closed position.

U.S. Pat. No. 3,407,514 shows a set of cylindrical or conical blocks that may be nested one in the other.

U.S. Pat. No. 4,778,392 shows a fourteen (14) sided block folded to have four (4) flat surfaces and one indented surface and one projecting surface. The indented surface and the projecting surface are shaped to be mating.

U.S. Pat. No. 4,875,681 shows a plurality of block joined together with a flexible joint (20).

While each of the foregoing has its own unique attributes, none of the foregoing provides a lightweight, portable, and compactly storable version of an educational toy based on the concept of the wooden block. Accordingly, there is a need for a lightweight, portable, and compactly storable version of an educational toy based on the concept of the wooden block.

### SUMMARY OF THE INVENTION

An educational toy has four panels. Each panel is joined to the next panel with a hinge. Each panel has an outwardly facing surface. Educational information is disposed on each said surface. In an open position, the panels define a hollow cube, and in a closed position, the panels define a flat structure. The educational information may include, without limit, letters, numbers, pictures, phrases, and combinations thereof. When the toy is in the closed position, one toy may be nested into another toy.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is an illustration of the educational toy in an open position.

FIG. 2 is an illustration of the educational toy in a closed (or collapsed) position.

FIG. 3 is an illustration of nesting one educational toy into another educational toy.

FIG. 4 is an illustration of several stacked educational toys.

### DESCRIPTION OF THE INVENTION

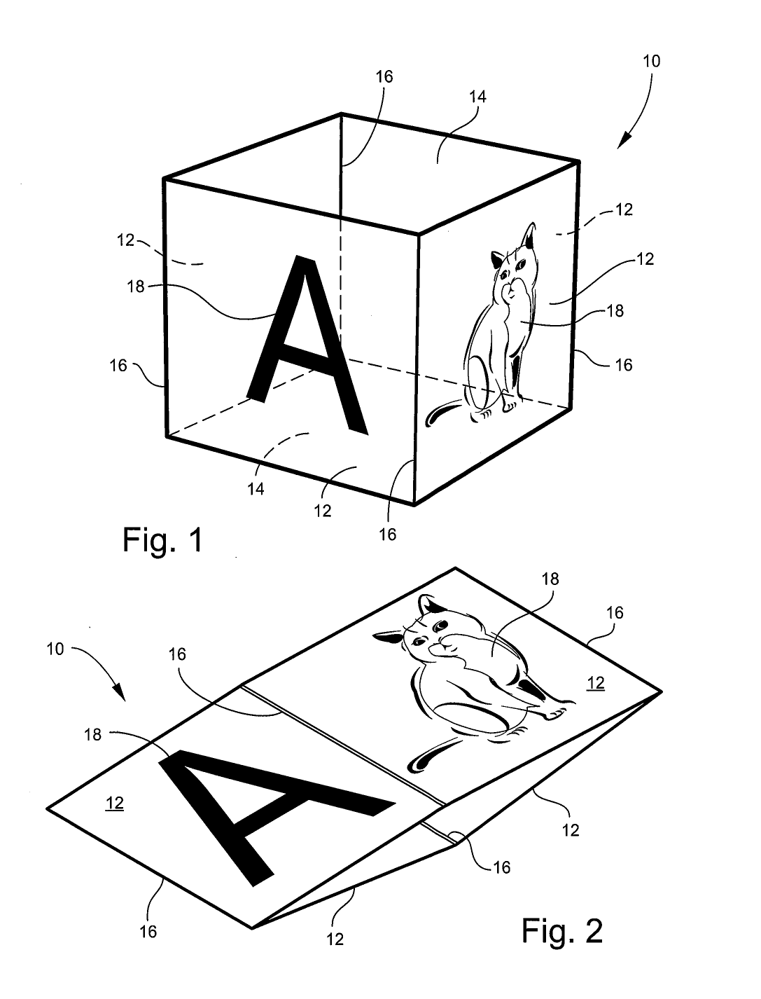

Referring to the drawings, wherein like elements have like numerals, there is shown, in FIG. 1, an educational toy 10 in an open position. Toy 10 includes four panels 12. Each panel is joined to the next by a hinge 16. In the open position, the toy 10 defines a polygon. In one embodiment, the toy 10, in the open position, defines a hollow block (or cube) with an opening 14 at the top and bottom. In FIG. 2, the educational toy 10 is shown in a closed (or collapsed) position.

Panels 12 are rectangular, e.g., square. In one embodiment, each panel may have dimensions in the range of 2-4 inches. In another embodiment, each panel may have the square dimension of about 3 inches. The panel may be made of any material. Such materials may include paper, cardboard, and/or plastic. Plastics may include polyvinyl chloride (PVC), polyolefins (polyethylene (PE), polypropylene (PP), polybutylene (PB)), polystyrene (PS), and/or polyester (PET). In one embodiment, the panel may range in thickness from 0.012 to 0.050 inches. In another embodiment, the panel may have a thickness of about 0.024 inches.

Hinges 16 join each panel 12 to the next. The hinges may be integral with the panels or they may be discrete (i.e., joined to the panels). If the hinges are integral with the panels, they will be made of the same material as the panels. If the hinges are discrete, they may be made of a material different from the panels. The material of the discrete hinge may be any material. In one embodiment, the hinge material may be plastic. Plastics may include polyvinyl chloride (PVC), polyolefins (polyethylene (PE), polypropylene (PP), polybutylene (PB)), and/or polyester (PET). An integral hinge may further include a scored line to facilitate pivoting. A discrete hinge may be joined to a panel in any manner. Such joining may include, for example, gluing, spot welding, line welding (welding by heat or ultrasonic energy), taping.

Each panel has an outwardly facing surface. Educational material 18 may be placed on the outwardly facing surface. Educational material may be any information that could be of interest to a learner. For example, educational material includes, but is not limited to: letters (e.g., A, a, B, b, C, c . . . ); numbers (e.g., 1, 2, 3, 4, 5, 6, 7, 8, 9, 0); pictures of animals (e.g., dog, cat, bird, squirrel, rabbit, bull, cow, sheep, rooster, chicken, camel, elephant, llama, giraffe, lion, moose, fox, jaguar, monkey, snake, insects); pictures of common items (e.g., car, bus, train, plane, rocket ship, knife, fork, spoon); pictures of famous places and landmarks (e.g., White House, Capital Building, Washington's Monument, Mount Rushmore, Grand Canyon, Yellowstone National Park (geysers), moon, heavenly bodies); maps (e.g., shapes of states, states of countries, shapes of continents, shapes of oceans, shapes of lakes, shapes of mountains); famous persons (e.g., George Washington, Thomas Jefferson, Abraham Lincoln, Albert Einstein); geometric shapes (e.g., circles, squares, rectangles, triangles, ovals, stars, semicircles, hearts); colors (e.g., red, orange, yellow, green, blue, indigo, violet); mythical or literary figures (e.g., Cinderella, Snow White, the Seven Dwarves, Beauty and the Beast, the Little Mermaid); arithmetic symbols (e.g., +, −, ×, +, =, <, >, ≦, ≧. . . ); phrases (e.g., common expression, secular, spiritual, religious); and foreign phrases. Educational material may also include: photographs (e.g., photographs of family members, or places of interest, or children of different nationalities or ethnicities). Educational material may also be used to depict a story.

The educational toy 10 may be further adorned with other decorations 20. Such decorations may include, but are not limited to, glitter, fragrances, fluorescent paint (glow-in-the-dark). Such decorations may be affixed to the outwardly facing surface of the panels and/or impregnated into the material forming the panels. Additionally, an anti-microbial material may be incorporated into the toy.

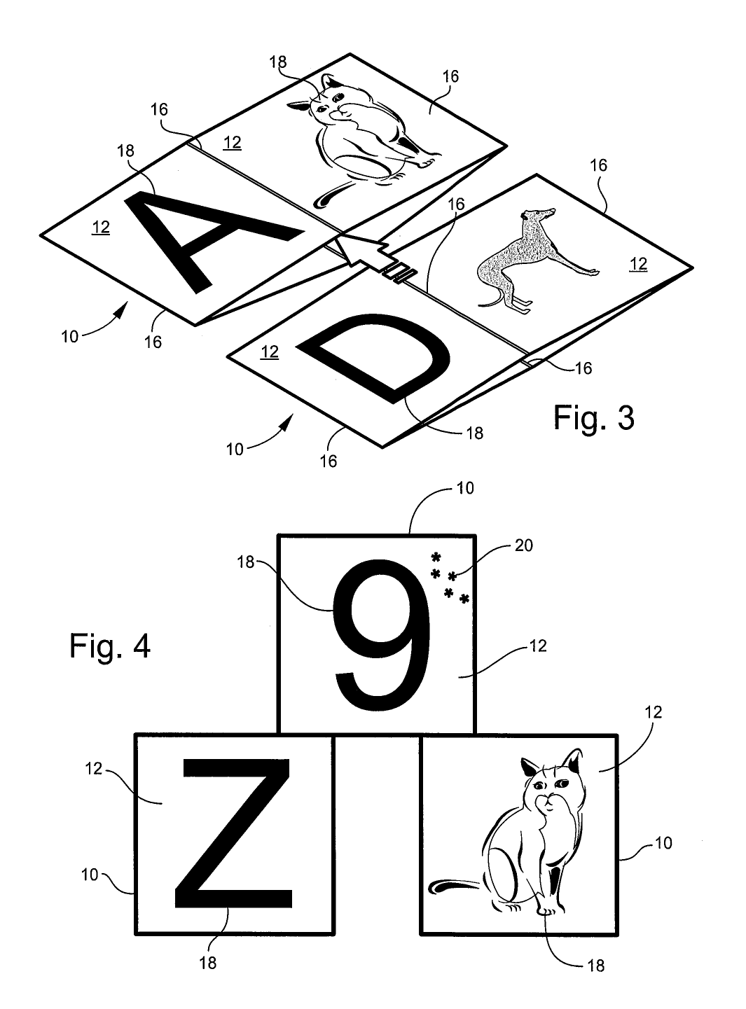

In FIG. 3, there is shown that at least one educational toy 10, when in the closed position, may be inserted into another educational toy 10, in a closed (or mostly closed) position. By so doing, several educational toys may be stored in a flat and compact manner.

In FIG. 4, there is shown several of the educational toys 10 in a stacked relationship. These toys 10, when in their open position, may be used as any ordinary wooden block, i.e., to build walls, pyramids, columns, and other simple objects.

The present invention may be embodied in other forms without departing from the spirit and the essential attributes thereof, and, accordingly, reference should be made to the appended claims, rather than to the foregoing specification, as indicating the scope of the invention.

1. An educational toy consisting of:
four panels, each panel being joined to the next panel with a discrete hinge, said hinge being welded to each said panel, each panel having an outwardly facing surface, and educational information being disposed on each said surface, wherein in an open position the panels define a hollow cube, and in a closed position, the panels define a flat structure.

2. The educational toy according to claim 1 wherein, in the closed position, one toy is nested into another toy.

3. The educational toy according to claim 1 wherein the educational information is selected from the group consisting of letters; numbers; pictures of animals; pictures of common items; pictures of famous places and landmarks; maps; famous persons; geometric shapes; colors; mythical or literary figures; arithmetic expressions; phrases; foreign phrases, photographs, story, and combinations thereof.

4. The educational toy according to claim 1 wherein each said panel is square.

5. The educational toy according to claim 4 wherein an edge dimension of said square is in the range of 2-4 inches.

6. The educational toy according to claim 5 wherein the dimension of the square is about 3 inches.

7. The educational toy according to claim 1 wherein said panel has a thickness dimension in the range of 0.012-0.050 inches.

8. The educational toy according to claim 7 wherein said panel has the thickness dimension of about 0.024 inches.

9. The educational toy according to claim 1 wherein said panel is made of paper, cardboard, or plastic.

10. The educational toy according to claim 9 wherein said plastic is selected from the group consisting of polyvinyl chloride, polyolefins, polystyrene, polyester, and combinations thereof.

11. (canceled)

12. (canceled)

13. (canceled)

14. (canceled)

15. The educational toy according to claim 1 is further adorned with glitter or fragrances affixed to or impregnated into said panels.

16. The educational toy according to claim 1 further comprising an anti-microbial material affixed to or impregnated into said panels.
